(19) United States
(12) Patent Application Publication
(10) Pub. No.: US 2023/0032674 A1
(43) Pub. Date: Feb. 2, 2023

(54) GRANULAR MATERIALS BOX SYSTEM

(71) Applicant: Texas Materials Group, Inc., Cedar Park, TX (US)

(72) Inventor: Rodney Dale McCarn, JR., Cedar, TX (US)

(21) Appl. No.: 17/785,022

(22) PCT Filed: Dec. 14, 2020
(86) PCT No.: PCT/US2020/064954

§ 371 Date: Jun. 13, 2022

Related U.S. Application Data
(60) Provisional application No. 62/947,383, filed on Dec. 12, 2019.

(51) Int. Cl. B65D 88/30; B28C 7/04; B28C 7/00

(52) U.S. Cl. CPC B65D 88/30; B28C 7/0445; B28C 7/0084

(57) ABSTRACT

Described is a cementitious material delivery system having at least one material box (10) with a lower access point (16) that is connected to a collection hopper (22). Also described is a cementitious material delivery system having at least one container (38) with an unloading end (42) that is located proximate to a collection hopper (22). The at least one container (38) can be positioned on at least one shelf (18) that can be raised so that the unloading end (42) is tilted toward the collection hopper (22).

### CROSS REFERENCE TO RELATED APPLICATIONS

This application is related to an claims priority benefits from U.S. Provisional Application Ser. No. 62/947,383 (“the '383 application”), filed on Dec. 12, 2019, entitled “Granular Materials Box System.” The '383 application is hereby incorporated in its entirety by this reference.

### FIELD OF THE INVENTION

The field of the invention relates to concrete mixing processes and the like.

### BACKGROUND

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” “back,” and “corners,” among others, are intended to refer to the orientation as illustrated and described in the figure (or figures) to which the components and directions are referencing.

Granular materials are a collection of distinct solid particles that can behave, in many ways, like liquids or gases, which are able to flow and take on the shape of their containers. Granular materials are used in many basic products, such as building materials, chemicals, pharmaceuticals, and food. Some such granular materials include soils, sand, cement, fly ash (and other supplementary cementitious materials), coal, dry polymers, plastic granules, glass beads, glass microspheres, powders, flour, starch, sugar, salt, cornmeal, grains, etc. In the product manufacturing process, granular materials are often stored in silos. Granular materials are typically transported to the silos via bulk pneumatic tankers, which are designed to generate sufficient air pressure to “blow” the material from the tanker into the silo. In a typical delivery sequence to a ready mix concrete plant, for example, the driver connects the tanker to the silo fill pipe. After starting the truck-mounted or stationary compressor, the driver adjusts the airflow pressure and distribution so that the product in the pneumatic tanker is first fluidized and then transported under pressure through the discharge pipeline and into the receiving silo. As the compressed air enters the silo and expands, the powder falls into the silo, while the transport air is filtered of any entrained dust by the dust filter, and the cleaned air is released to the atmosphere through the vent pipe. To ensure dust emissions are minimized, the collected dust is automatically cleaned from the filter bags at regular intervals and returned to the silo. Frequent removal of the dust from the filters also helps ensure the large volumes of transport air pumped into the silo can be rapidly vented, minimizing the risk of silo over-pressurization and subsequent damage to equipment or injury to personnel. Such filtration systems are costly to procure, install, and maintain and often require the facility to obtain an air permit and monitor and report on emissions generated during the process. Thus, a less costly and more environmentally friendly system is needed in the ready mix concrete industry and other industries with similar concerns.

After the pneumatic tanker has been emptied, the driver shuts off the compressor, carefully vents any excess pressure from the tanker, and closes the silo fill valve. The connecting hose is removed and stored and any spills are cleaned up before the driver closes off the silo and departs.

One pneumatic truck load of cementitious materials is approximately 25 tons and requires approximately one hour to empty into a silo. The lack of efficient unloading techniques has taken a heavy toll on the efficiencies of trucking fleets. When trucking companies are required to wait in line to be loaded, or wait at a plant to be unloaded, the number of turns that the equipment can make in a day is severely limited. Rather than turning two or three loads in a single day, the trucks more typically make one trip per day because of extended times it takes unloading the product. As a result, the trucking company must often buy more equipment and hire more drivers to move the same amount of material. Thus, a faster and less just-in-time delivery system is needed to improve efficiency in the ready mix concrete industry and other industries with similar concerns.

The fracking industry experienced a similar issue in the logistics chain when the demand for proppant at well-sites soared in the “Shale Boom” period. U.S. Pat. No. 8,668,430 describes a process by which the proppant (typically sand, ceramic, or other particulates that prevent fractures from closing when injection is stopped) is transported and delivered to a well-site using proppant containers, instead of pneumatic tankers. These proppant containers are designed to empty the aggregate proppant by tilting or by gravity-flow through the bottom of the container. Such a design works well with non-clumping and/or heavier materials, but does not sufficiently address the use of such containers with low cohesion, low friction materials (such as fly ash or glass microspheres, which may fall back on themselves when conveyed uphill) or strong cohesion, strong friction materials (such as cement, flour, or powders, which may bridge over and cake or clog feeder mechanisms). Thus, it is desirable to adapt such a system to the use of such materials used in the ready mix concrete industry and other industries with similar concerns.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a cementitious material delivery system comprises at least one material box comprising a lower access point; and an enclosed chute connected to the lower access point and a collection hopper. In some embodiments, an enclosed auger is connected to the collection hopper and a weighed collection hopper, wherein the weighed collection hopper feeds into a ready mix concrete drum. In further embodiments, an enclosed auger is connected to the collection hopper and a storage or transport vessel. The enclosed auger may be positioned with a pitch of less than 60 degrees.

According to some embodiments, dust production is less than 50% of dust production using a pneumatic delivery system. Furthermore, the reduction in dust production may be achieved without use of a dust collection system. The system may be configured to transport fly ash, cement, granulated blast furnace slag, or other powdered material used in production of ready mixed concrete.

According to certain embodiments of the present invention, a cementitious material delivery system comprises at least one container comprising an unloading end; a stand comprising at least one shelf having a lowered position and a raised position, the at least one container positioned on the at least one shelf; a collection hopper positioned proximate to the unloading end of the at least one container; and an enclosed auger connected to the collection hopper. In these embodiments, when the at least one shelf is in the raised position, the unloading end of the at least one container is tilted toward the collection hopper.

In some embodiments, the at least one container has a length of at least 20 feet and/or has an unloaded total weight that is less than 5000 lbs.

In certain embodiments, an enclosed chute may connect the unloading end of the at least one container to the collection hopper. Furthermore, a weighed collection hopper may be connected to the enclosed auger, wherein the weighed collection hopper feeds into a ready mix concrete drum. The enclosed auger may be connected to a storage or transport vessel.

According to some embodiments, the raised position may be tilted relative to the lowered position by at least 15 degrees, and may further be tilted relative to the lowered position in a range between 15 degrees to 60 degrees.

### BRIEF DESCRIPTION OF THE DRAWINGS

FIG. 1 is a front view of a granular materials box, according to certain embodiments of the present invention.

FIG. 2 is a front view of a granular materials box system with multiple stands feeding into a collection hopper, according to certain embodiments of the present invention.

FIG. 3 is a front view of the granular materials box system of FIG. 2 showing the placement of rubber boots, according to certain embodiments of the present invention.

FIG. 4 is a side view of a granular materials box system with a collection hopper paired with an individual stand and feeding into a weighed collection hopper, according to certain embodiments of the present invention.

FIG. 5 is a side view of the granular materials box system of FIG. 4 showing the placement of rubber boots and bracing, according to certain embodiments of the present invention.

FIG. 6 is a side view of a granular materials box system with a collection hopper paired with an individual stand and feeding into a portable or stationary vessel, according to certain embodiments of the present invention.

FIG. 7 is a front view of a granular materials container system with multiple stands feeding into a collection hopper, according to certain embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” “back,” and “corners,” among others, are intended to refer to the orientation as illustrated and described in the figure (or figures) to which the components and directions are referencing.

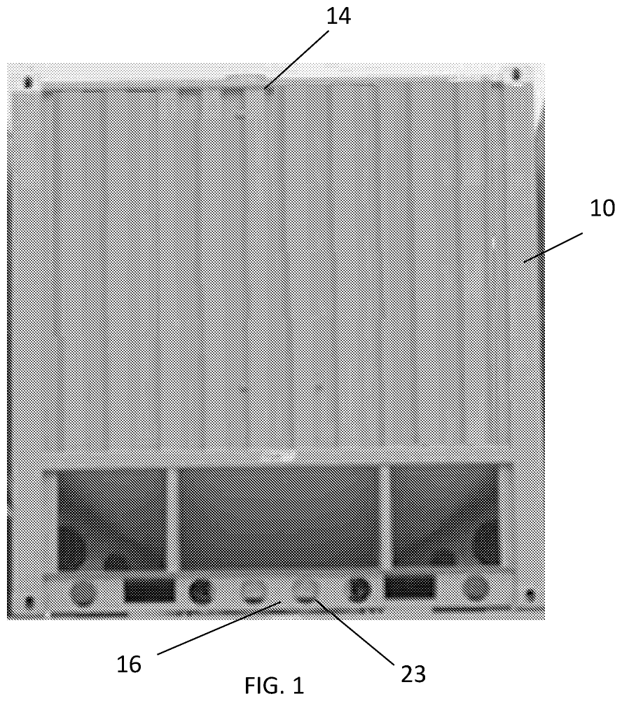

According to certain embodiments, as best illustrated in FIG. 1, granular material boxes 10 are used to load, unload, and mix cementitious materials. In these embodiments, the box 10 comprises an upper access point 14 and a lower access point 16. The box 10 is loaded through the upper access point 14, while the lower access point 16 remains closed and/or sealed. Once loaded, the upper access point 14 is also closed and/or sealed, thereby forming a water-tight (and potentially air-tight) enclosure for the cementitious material. The cementitious material may include supplementary cementitious materials (e.g., fly ash, ground granulated blast furnace slag, silica fume, natural pozzolans), cement, fine aggregates (e.g., sand), hydrated lime, powdered admixtures, dry polymers, or other materials capable of being transported via the described material handling system. The cementitious materials may have a range of properties that require different treatments for effective and efficient loading and unloading from the boxes 10. For example, fly ash has a significantly lower density than that of cement.

Each box 10 is sized to hold approximately 12-14 tons of fly ash, and 19-21 tons of cement. Two boxes 10 are equivalent to 1 pneumatic tanker load. Because of the pre-loaded nature of the boxes 10, a truck delivering two boxes can be unloaded in approximately 5 minutes (versus approximately 1 hour to unload the equivalent amount from a pneumatic tanker). Rail delivery costs can also be significantly reduced because of the faster unloading of cars compared to current practices of gravity fall or pneumatic unloading; thereby generating a significant decrease in demurrage costs. The boxes 10 are unloaded with a forklift, wheel loader, crane, or other container handler (e.g., an RT290 RTCH) and placed on-site for future use. In other words, the truck does not have to wait in line to unload directly into a silo, thus virtually eliminating long wait times for truck deliveries. In addition to the savings realized from reduced wait times, the costs associated with a flatbed trailer are at least $15-20 /hour less than those for a pneumatic tanker, which further reduces transportation costs.

Furthermore, the processing and loading times at the plants of origin will be positively affected because of the ability of off-peak hours loading and pick-up, which will decrease wait times and total cost of cartage.

An additional benefit of eliminating the pneumatic tanker delivery is a significant reduction in the amount of dust produced. With the pneumatic system, as described above, a dust collection system must be installed and maintained on the silo to collect the dust created by the pneumatic system. Installation and maintenance of a dust collection system is a significant expense that can be eliminated with the box system.

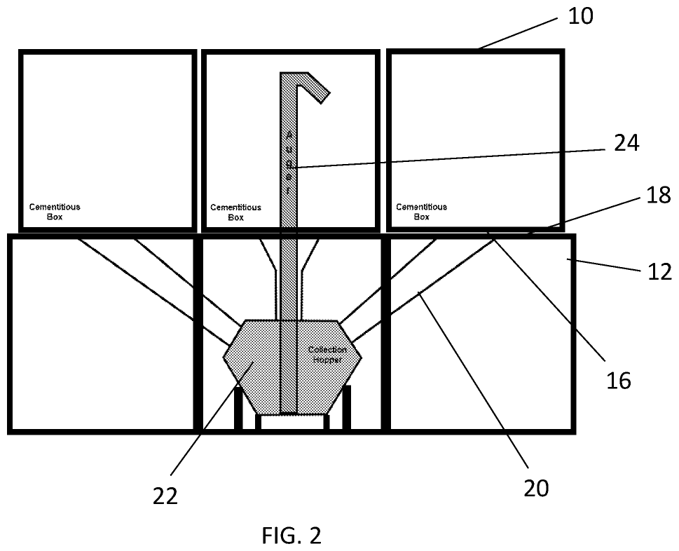

According to some embodiments, as illustrated in FIGS. 2-5, once the box 10 is ready to be unloaded into the process, the container handler retrieves the box 10 from its storage location on-site and places it on a stand 12. The stand 12 comprises an upper shelf 18, which is configured to receive and hold the box 10. A chute 20 may be positioned below the upper shelf 18. The upper shelf 18 may also engage with the lower access point 16 to open it and allow the material to begin gravity-flowing into the chute 20. The lower access point 16 may include a metering gate 23 that can be adjusted to achieve the desired flow rate of the materials through the lower access point 16.

In addition to the use of gravity feeding, the stand 12 may also comprise a series of shocks, vibrators, aeration pads/compressors, or other devices that interact with the box 10 to dislodge any material that may have bridged over or clumped together within the box 10.

The upper shelf 18 may further join the lower access point 16 to an upper end of the chute 20 to keep the materials protected from exposure to the weather and/or to prevent any dust from being released as the material travels from the box 10 to the chute 20.

The chute 20 may then feed into a collection hopper 22, which in turn feeds the material onto an auger, belt conveyor, slat conveyor, or other type of conveyor 24. The connection between the chute 20 and the collection hopper 22 may be sealed with a rubber boot 34 or other similar device to protect the materials from exposure to the weather and/or to prevent any dust from being released between the chute 20 and the collection hopper 22. The collection hopper may have load cells and a scale system added for weighed conveyance direct into a vessel in some applications.

The angle of the auger should be specified to accommodate the type of material. Because of the light nature of fly ash, for example, the angle of the auger 24 leaving the collection hopper 22 may not have a pitch that exceeds 60 degrees, as an example, as a greater pitch will cause the fly ash material to roll back on itself instead of traveling up the auger 24.

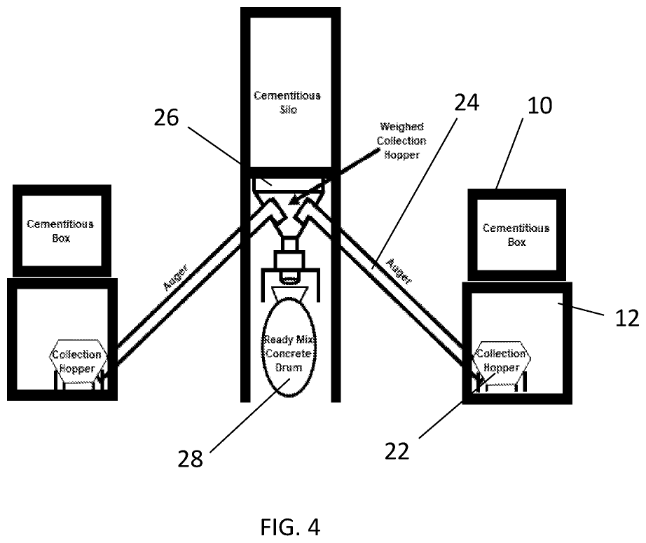

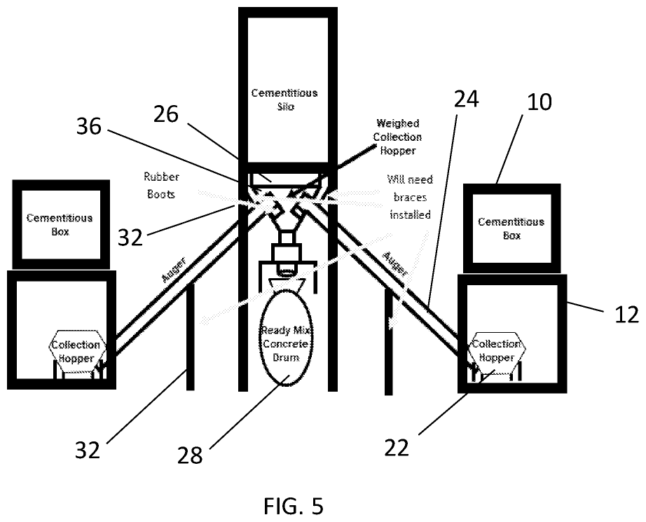

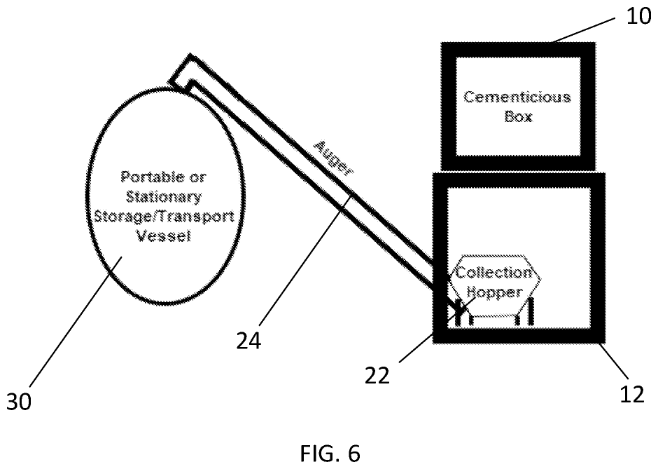

As illustrated in FIGS. 4-5, an upper end of the auger 24 may feed into a weighed collection hopper 26, which in may feed the product directly into a ready mix concrete drum 28. In other embodiments, as shown in FIG. 6, an upper end of the auger 24 may feed into a portable or stationary storage/transport vessel 30. In these embodiments, the connection between the auger 24 and the weighed collection hopper 26 may be sealed with a rubber boot 36 or other similar device to again protect the materials from exposure to the weather and/or to prevent any dust from being released between the auger 24 and the weighed collection hopper 26. Furthermore, where a longer distance is needed to create the necessary pitch of the auger 24, as illustrated in FIG. 5, the auger 24 may require bracing 32 or some other structural reinforcement or support in at least one location between the collection hopper 22 and the weighed collection hopper 26 or the portable or stationary storage/transport vessel 30.

The amount of dust produced by the above system is a more than 50% reduction over the amount of dust produced by the pneumatic system prior to entering the dust collection system. In some case, the amount of dust reduction is more than 75%, and may further be more than 90%. In any event, the above system eliminates the need for a dust collection system.

In further embodiments, one or more shipping containers 38 or other similar containers may be used to introduce the materials into the process. In these embodiments, the stand 12 may be modified so that the upper shelf 18 has a larger surface area to support the larger dimensions of the container 38. In certain embodiments, the containers 38 may be 20 feet in length and/or may be a standard 20 ft shipping container. In further embodiments, the container 38 may have similar overall dimensions to a standard 20 ft shipping container, but may have been modified to use lighter construction materials to reduce the total weight of the container 38. For example, the total weight of an unloaded container 38 may be less than 5000 lbs, and further may be less than 4000 lbs, and still further may be less than 3500 lbs. The container 38 may further have been modified on at least one end 42 to include at least one of a load or unload location.

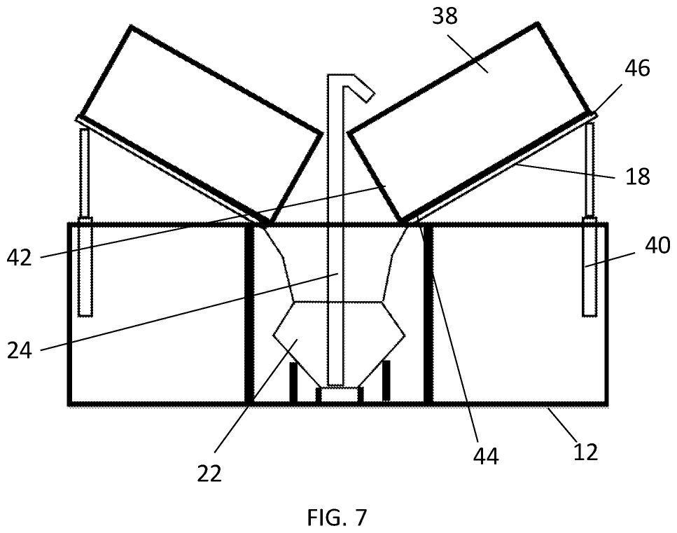

In these embodiments, the upper shelf 18 comprises an end 44 and an opposing end 46. In order to empty the container 38, the upper shelf 18 may be coupled to the stand 12 in a manner that allows the unloading end 42 of the container 38 to be tilted toward the collection hopper 22, as illustrated in FIG. 7. In these embodiments, the end 44 of the upper shelf 18 (which is closest to the collection hopper 22) may be pivotally coupled to the stand 12. When the container 38 is positioned on the upper shelf 18, the unloading end 42 of the container 38 is positioned proximate to the end 44 of the upper shelf 18.

When the upper shelf 18 is in a lowered position, the upper shelf 18 is in a substantially horizontal position where both ends 44, 46 are located at substantially the same height. In contrast, when the upper shelf 18 is in a raised position (as best shown in FIG. 7), the end 46 is at a higher position relative to the ground than the end 44, thereby causing the unloading end 42 of the container 38 to be tilted toward the collection hopper 22.

In some embodiments, the upper shelf 18 and the stand 12 may be configured so that the raised position is achieved by lifting the end 46, while the end 44 remains at substantially the same height. In these embodiments, a lifting device 40, such as a hydraulic ram, gas spring hydraulic jack, pneumatic cylinder, hydraulic lift table, scissor-lift table, tilt table, or any other suitable lifting arrangement that can raise the end 46 of the upper shelf 18 (and thereby tilt the container 38) may be coupled to the end 46 of the upper shelf 18 and/or to the stand 12.

In other embodiments, the upper shelf 18 and the stand 12 may be configured so that the raised position is achieved by lowering the end 44, while the end 46 remains at substantially the same height. In these embodiments, the lifting device 40, such as a hydraulic ram, gas spring, hydraulic jack, pneumatic cylinder, hydraulic lift table, scissor-lift table, tilt table, or any other suitable lifting arrangement that can lower the end 44 of the upper shelf 18 (and thereby tilt the container 38) may be coupled to the end 44 of the upper shelf 18 and/or to the stand 12.

In certain embodiments, the lifting device 40 may be oriented in a substantially vertical position, as shown in FIG. 7. In further embodiments, the lifting device 40 may be angled so as to push up toward the center of the upper shelf 18.

In still further embodiments, the container 38 may be upended a full 90 degrees or more so as to transfer the material to the unloading end 42 in a manner that minimizes or eliminates air pockets when the material is released from the container 38. Such a design may be useful for dust control or other transfer concerns due to properties of the material.

In yet other embodiments, the container 38 may be unloaded in any suitable manner that is known in the conveyance industry that provides a transfer of material into the collection hopper 22.

The difference in height between the ends 44, 46 may cause the upper shelf 18 (and thus the container 38) to be positioned with a degree of tilt toward the collection hopper 22 that may range from greater than 5 degrees, may further range from 5 degrees to 95 degrees, may still further range from 5 degrees to 90 degrees, may still further range from 10 degrees to 85 degrees, may still further range from 15 degrees to 80 degrees, may still further range from 20 degrees to 75 degrees, may still further range from 25 degrees to 70 degrees, may still further range from 30 degrees to 65 degrees, may still further range from 35 degrees to 55 degrees, may still further range from 40 degrees to 50 degrees, may still further range from 15 degrees to 25 degrees, may still further range from 20 degrees to 30 degrees, may still further range from 25 degrees to 35 degrees, may still further range from 35 degrees to 45 degrees, may still further range from 40 degrees to 50 degrees, may still further range from 50 degrees to 60 degrees, may still further range from 60 degrees to 70 degrees, may still further range from 70 degrees to 80 degrees, and may still further range from 80 degrees to 90 degrees, and may still further range from greater than 90 degrees.

Moreover, the degree of tilt may be related to the type of product being transferred. For example, products with a low cohesion/low friction may require a degree of tilt in the lower ranges, while products with a strong cohesion/strong friction may require a degree of tile in the mid to upper ranges.

As best illustrated in FIG. 7, an opening at the top of the collection hopper 22 may be modified so that the unloading end 42 of the container 38 can dispense the materials directly into the collection hopper 22 without the need for an additional chute 20.

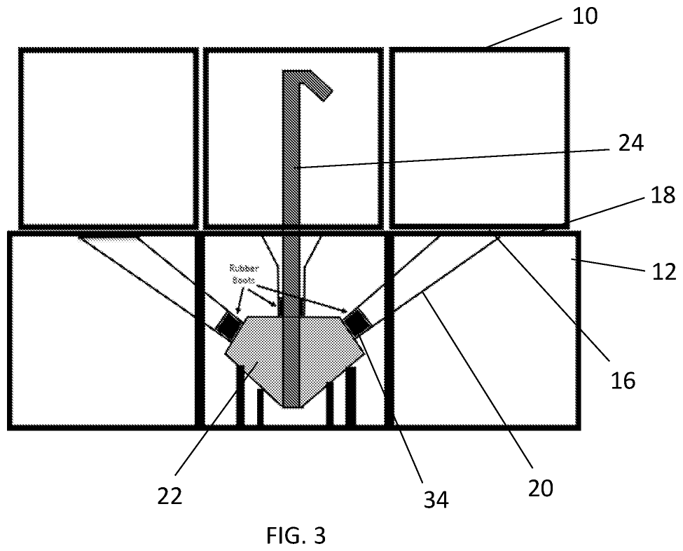

In further embodiments, the unloading arrangement may include a chute 20 to connect the unloading end 42 with the collection hopper 22 similar to the chutes 20 illustrated in FIGS. 2-3. As described above, a metering gate 23 may also be incorporated to control the flow rate of materials into the collection hopper 22. The upper shelf 18 may further join the unloading end 42 to an upper end of the chute 20 to keep the materials protected from exposure to the weather and/or to prevent any dust from being released as the material travels from the box 10 to the chute 20.

In addition to the use of gravity feeding, the stand 12 may also comprise a series of shocks, vibrators, aeration pads/compressors, or other devices that interact with the collection hopper 22 to dislodge any material that may have bridged over or clumped together within the collection hopper 22.

Like the boxes 10, the containers 38 may be positioned on the upper shelf 18 using a forklift, wheel loader, crane, or other container handler (e.g., an RT290 RTCH) from a storage location on-site. Because the containers 38, like the boxes 10, provide a similar ability to be offloaded from a delivery truck and used at a future time, the advantages discussed above with respect to use of the boxes 10 also apply to the use of the container 38. Furthermore, because the container 38 volume is larger than the box 10 volume, a full load (approx. 25 tons) may be stored in one container 38 rather than two boxes 10, which reduces the amount of handling needed by as much as 50%.

While the detailed description of the invention is focused on ready mix concrete applications, it should be understood that the details described are not specific to ready mix concrete and may be applicable to any other industry in which granular materials are used. In food or pharmaceutical applications, for example, the auger 24 could be replaced with a dosing screw (such as those disclosed and referenced in U.S. patent application Ser. No. 16/074884).

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

In the following, further examples are described to facilitate the understanding of the invention:
Example A. A cementitious material delivery system comprising:
   at least one material box comprising a lower access point;
   an enclosed chute connected to the lower access point and a collection hopper; and
   an enclosed auger connected to the collection hopper and a weighed collection hopper;
   wherein the weighed collection hopper feeds into a ready mix concrete drum.
Example B. A cementitious material delivery system comprising:
   at least one material box comprising a lower access point;
   an enclosed chute connected to the lower access point and a collection hopper; and
   an enclosed auger connected to the collection hopper and a storage or transport vessel.
Example C. The cementitious material delivery system of any of the preceding or subsequent examples, wherein the enclosed auger is positioned with a pitch of less than 60 degrees.
Example D. The cementitious material delivery system of any of the preceding or subsequent examples, wherein dust production is less than 50% of dust production using a pneumatic delivery system.
Example E. The cementitious material delivery system of any of the preceding or subsequent examples, wherein the reduction in dust production is achieved without use of a dust collection system.
Example F. The cementitious material delivery system of any of the preceding or subsequent examples, wherein the system is configured to transport fly ash, cement, granulated blast furnace slag, or other powdered material used in production of ready mixed concrete.
Example G. A cementitious material delivery system comprising:
   at least one container comprising an unloading end;
   a stand comprising at least one shelf having a lowered position and a raised position, the at least one container positioned on the at least one shelf,
   a collection hopper positioned proximate to the unloading end of the at least one container; and
   an enclosed auger connected to the collection hopper;
   wherein, when the at least one shelf is in the raised position, the unloading end of the at least one container is tilted toward the collection hopper.
Example H. The cementitious material delivery system of any of the preceding or subsequent examples, wherein the at least one container has a length of at least 20 feet.

Example I. The cementitious material delivery system of any of the preceding or subsequent examples, wherein the at least one container has an unloaded total weight that is less than 5000 lbs.
Example J. The cementitious material delivery system of any of the preceding or subsequent examples, further comprising an enclosed chute connecting the unloading end of the at least one container to the collection hopper.

Example K. The cementitious material delivery system of any of the preceding or subsequent examples, further comprising a weighed collection hopper connected to the enclosed auger, wherein the weighed collection hopper feeds into a ready mix concrete drum.

Example L. The cementitious material delivery system of any of the preceding or subsequent examples, wherein the enclosed auger is connected to a storage or transport vessel.

Example M. The cementitious material delivery system of any of the preceding or subsequent examples, wherein the raised position is tilted relative to the lowered position by at least 15 degrees.

Example N. The cementitious material delivery system of any of the preceding or subsequent examples, wherein the raised position is tilted relative to the lowered position in a range between 15 degrees to 60 degrees.

That which is claimed:

1. A cementitious material delivery system comprising:
at least one material box comprising a lower access point;
an enclosed chute connected to the lower access point and a collection hopper; and
an enclosed auger connected to the collection hopper and a weighed collection hopper;
wherein the weighed collection hopper feeds into a ready mix concrete drum.

2. The cementitious material delivery system of claim 1, wherein the enclosed auger is positioned with a pitch of less than 60 degrees.

3. The cementitious material delivery system of claim 1, wherein dust production is less than 50% of dust production using a pneumatic delivery system.

4. The cementitious material delivery system of claim 3, wherein the reduction in dust production is achieved without use of a dust collection system.

5. The cementitious material delivery system of claim 1, wherein the system is configured to transport fly ash, cement, granulated blast furnace slag, or other powdered material used in production of ready mixed concrete.

6. A cementitious material delivery system comprising:
at least one material box comprising a lower access point;
an enclosed chute connected to the lower access point and a collection hopper; and
an enclosed auger connected to the collection hopper and a storage or transport vessel.

7. The cementitious material delivery system of claim 6, wherein the enclosed auger is positioned with a pitch of less than 60 degrees.

8. The cementitious material delivery system of claim 6, wherein dust production is less than 50% of dust production using a pneumatic delivery system.

9. The cementitious material delivery system of claim 8, wherein the reduction in dust production is achieved without use of a dust collection system.

10. The cementitious material delivery system of claim 6, wherein the system is configured to transport fly ash, cement, granulated blast furnace slag, or other powdered material used in production of ready mixed concrete.

11. A cementitious material delivery system comprising:
at least one container comprising an unloading end;
a stand comprising at least one shelf having a lowered position and a raised position, the at least one container positioned on the at least one container;
a collection hopper positioned proximate to the unloading end of the at least one container; and
an enclosed auger connected to the collection hopper;
wherein, when the at least one shelf is in the raised position, the unloading end of the at least one container is tilted toward the collection hopper.

12. The cementitious material delivery system of claim 11, wherein the at least one container has a length of at least 20 feet.

13. The cementitious material delivery system of claim 12, wherein the at least one container has an unloaded total weight that is less than 5000 lbs.

14. The cementitious material delivery system of claim 11, wherein dust production is less than 50% of dust production using a pneumatic delivery system.

15. The cementitious material delivery system of claim 14, wherein the reduction in dust production is achieved without use of a dust collection system.

16. The cementitious material delivery system of claim 11, wherein the system is configured to transport fly ash, cement, granulated blast furnace slag, or other powdered material used in production of ready mixed concrete.

17. The cementitious material delivery system of claim 11, further comprising an enclosed chute connecting the unloading end of the at least one container to the collection hopper.

18. The cementitious material delivery system of claim 11, further comprising a weighed collection hopper connected to the enclosed auger, wherein the weighed collection hopper feeds into a ready mix concrete drum.

19. The cementitious material delivery system of claim 11, wherein the enclosed auger is connected to a storage or transport vessel.

20. The cementitious material delivery system of claim 11, wherein the raised position is tilted relative to the lowered position by at least 15 degrees.

21. The cementitious material delivery system of claim 19, wherein the raised position is tilted relative to the lowered position in a range between 15 degrees to 60 degrees.
